(19) United States
(12) Patent Application Publication
(10) Pub. No.: US 2018/0294518 A1
(43) Pub. Date: Oct. 11, 2018

(54) Solid State Integrated Electrode/Electrolyte System

(71) Applicant: Northeastern University, Boston, MA (US)

(72) Inventors: Sanghyun HONG, Malden, MA (US); Yung Joon JUNG, Lexington, MA (US); Rodrigo Lasserote LAVALL, Valença (BR); Hyehee KIM, Boston, MA (US); Ahmed BUSNAINA, Needham, MA (US)

(21) Appl. No.: 15/941,870

(22) Filed: Mar. 30, 2018

Related U.S. Application Data
(60) Provisional application No. 62/478,988, filed on Mar. 30, 2017.

(51) Int. Cl. H01M 10/0562; H01M 10/0525; H01M 4/583; H01M 2/14; H01G 11/06; H01G 11/36; H01G 11/56; H01G 11/52

(52) U.S. Cl. CPC H01M 10/0562; H01M 10/0525; H01M 4/583; H01M 2/14; H01M 2004/027; H01G 11/36; H01G 11/56; H01G 11/52; H01M 2300/0082; H01G 11/06

(57) ABSTRACT

An electrode-electrolyte system for use in batteries and supercapacitors allows enhanced access of ions and electrons from the electrolyte to the electrode. The electrode includes an electrically conductive substrate, a nanostructured active material layer deposited on the substrate, and a porous membrane coating the nanostructured active material. The porous membrane is flexible and made of a polymer network and a conductive additive.

### CROSS REFERENCE TO RELATED APPLICATIONS

This application claims the priority of U.S. Provisional Appl. No. 62/478,988, filed Mar. 30, 2017 and entitled “Highly Integrated, Porous, Flexible, and Miniaturizable Electrode/Electrolyte System for Energy Storage Applications”, which is hereby incorporated by reference in its entirety.

### BACKGROUND

Traditional batteries and supercapcitors contain two electrodes, a liquid electrolyte, and a semi-permeable membrane separating the electrodes. A typical battery or supercapacitor cell is assembled by stacking two active material-containing metal foil electrodes and separating the two by an inert membrane soaked in a liquid electrolyte solution. In Li ion batteries, lithium salts dissolved in organic carbonate solvents such as ethylene carbonate, dimethyl carbonate, or diethyl carbonate, serve as the electrolyte. A cell designed in this manner has certain disadvantages. Its flexibility is limited by the metal foils. Also, the active materials may detach from the metallic collectors due to poor adhesion, and the electrolyte may leak, any of which leads to poor cycling. Solid-state electrolytes have been used to avoid these issues, to reduce weight, and to increase options with regard to volume and shape.

A solid-state electrolyte should possess high ionic conductivity, negligible electronic conductivity, a wide electrochemical window, and thermal and mechanical stability. One difference between liquid and solid-state electrolytes is the wetting of the electrode by the electrolyte. A liquid electrolyte can easily penetrate a porous active material and provide good contact with the material (FIG. 1A). However, when a typical solid-state electrolyte is used with active materials having high porosity, contact between the active material and the electrolyte is reduced to point-to-point contact (FIG. 1B), resulting in poor integration of the electrode and the electrolyte, which limits charging and discharging rates.¹

Gel polymer electrolytes exhibit superior conductivity compared to solid-state electrolytes based on conventional polymer-salt complexes. Studies on solid-state supercapacitors and lithium ion batteries have described the use of gel polymer electrolytes in a simple sandwich assembly where a polymer electrolyte film is placed between the electrodes. However, the poor electrode-electrolyte interface, characteristic of such assemblies, results in high internal resistance, limiting energy delivery rate and power density.²

Hydrogel electrolytes can improve the interface between solid-state electrolytes and electrodes.³⁻⁶ All solid-state energy devices have excellent mechanical and cycling stability. Further, due to the highly porous nature of the active material, they have highly improved accessibility of electrolytes to electrode surfaces. However, these devices are not suitable for industrial applications because their maximum operation voltage is under 1V, and because they have relatively low energy density due to the fact that hydrogel electrolytes contain water.⁷

Nanostructured active materials provide benefits in terms of capacity, power, and cost. These benefits are related to the small size of the materials which reduces the path of diffusion of ions and electrons and accommodates strains associated with lithium insertion and removal reactions. However, problems associated with poor packing, which leads to a significant proportion of the nanomaterial remaining inactive, limits the energy that can be stored per unit volume or mass.

There is a need for new solid electrolyte systems that allow better integration with electrodes for high capacity energy storage and rapid charge and discharge rates.

### SUMMARY

The present technology provides an integrated and flexible electrode/solid-state electrolyte structure for use in supercapacitors and batteries. The integrated electrode/electrolyte system includes an electrically conductive substrate (electrode surface), a nanostructured active material layer deposited on the substrate, and a porous membrane coating the nanostructured active material. The porous membrane includes a polymer network and a conductive additive, is flexible, and enhances access of ions and electrons to the nanostructured active material.

As used herein, “nanostructured active material layer” refers to a layer of positive or negative electrode active material that is nanostructured, i.e., the material itself is made up of nanosized structures such as nanoparticles, nanowires, nanorods, and micro/nano sized 3D porous particles, or is mixed with a nanostructured material. Examples of suitable positive electrode active materials include lithium-transition metal oxides, such as LiCoO₂, LiNiO₂, LiMnO₂, LiMn₂O₄, and LiNi_{1-x-y}COₓM_{y}O₂ (where, 0≤x≤1, 0≤y≤1, 0≤x+Ey≤1, M is Al, Sr, Mg or La). Examples of suitable negative electrode active materials include lithium alloying compounds such as Si, Al, Sn, Sb, and Ge, as well as 3D porous silicon, silicon nanotubes, silicon nanowires, SiOx/C coating on Si nanoparticles, Si/CNT composite film, Co₃O₄ nanoparticles, Co₃O₄ nanowires, mesoporous Co₃O₄, SnS₂ nanoplates, SnS₂ nanoflowers, and CuO particles (1 μm and 0.15 μm). Examples of a nanostructured material which can be mixed with a positive or negative electrode active material include 3D nanomaterials such as carbon nanotubes, carbon nanocups, and graphene.

Embodiments of the integrated electrode/solid-state electrolyte system can include one or more of the following features. The conductive additive can be an acid, a salt, or an ionic liquid. In one embodiment, the conductive additive is phosphoric acid. Suitable ionic liquids include, for example, ionic liquids containing an imidazolium cation, a piperidinium cation, a pyrrolidinium cation, or an ammonium cation associated with an anion selected from a bis(trifluoromethansulfonyl)imide anion, a bis(fluorosulfonyl)imide anion, a tetrafluoroborate anion, and a hexafluorophosphate anion. An example is 1-butyl, 3-methylimidazolium chloride. Suitable ionic liquids are preferably liquid at ambient temperature, such as room temperature (15-30° C.) or less, such as ionic liquids including as cation 1-alkyl-3-methylimidazolium, 1-alkylpyridinium, N-methyl-N-alkylpyrrolidinium, ammonium, phosphonium, tetrafluoroborate or hexafluorophosphate combined with anions such as bistriflimide, triflate, tosylate, formate, alkylsulfate, or glycolate.

The nanostructured active material can include a carbon based 3D nanomaterial, an inorganic nanostructures material, or a hybrid of the two. In some embodiments, the carbon based 3D nanomaterial is selected from the group consisting of: assembled carbon nanotubes (CNT), vertically aligned carbon nanotubes, carbon nanocups, carbon nanofibers, graphene, doped graphene, a hybrid of CNT and graphene, a hybrid of CNT and carbon nanocups, and carbon black. The inorganic nanostructured material can be a nanoparticle, a nanowire, a nanosheet, each including a substance selected from the group consisting of: a metal/semiconductor, a metal oxide, a metal phosphide, a metal nitride, and a metal sulfide; or a nanocomposite comprising two or more of said substances. In some embodiments, the polymer of the polymer network is selected from the group consisting of: poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide), In other embodiments the polymer network contains a block copolymer containing two or more of any of the above polymers or other polymers.

By “nanocomposite” is meant a multiphase solid material in which one of the phases has one, two, or three dimensions of less than 100 nanometers, or structures having nanoscale repeat distances between the different phases that make up the material. Nanocomposites include porous media, colloids, gels, and copolymers, as well as the solid combination of a bulk matrix and nano-dimensional phase(s) differing in properties due to dissimilarities in structure and chemistry. The mechanical, electrical, thermal, optical, electrochemical, catalytic properties of the nanocomposite differ markedly from that of the component materials.

Another aspect of the present technology is a supercapacitor having two electrodes as described above. The electrolyte is a solid-phase electrolyte containing one or more conductive additives selected from the group consisting of: an acid, a salt solution, and an ionic liquid. For immiscible reagents and solvent combinations, a phase transfer catalyst such as a quaternary ammonium cation can be used.⁸

Yet another aspect of the present technology is a solid-state electrolyte containing a flexible porous membrane that encloses at least one conductive additive. The membrane contains a polymer network or matrix. The polymer of the polymer network can be selected from the group consisting of: poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide); and a block copolymer. The at least one conductive additive can be, for example, H₃PO₄, a salt, or an ionic liquid.

A further aspect of the present technology is a rechargeable or non-rechargeable battery having an anode and a cathode, each having a structure as described above. The pair of electrodes contains two matched electrode materials, each coated with a solid-phase electrolye containing one or more conductive additives, which combined provide the required battery chemistry. The conductive additives can be, for example, one or more salts selected from an alkali salt, an alkaline earth salt, and a transitional metal salt, such as NaClO₄, NaI, Mg(ClO₄)₂, LiClO₄, LiI, LiN(CF₃SO₂)₂, LiCF₃SO₃, LiBC₄O₈, AgNO₃, LiPF₆, LiBF₄, LiSbF₆, LiAsF₆, LiN(C₂F₅SO₂)₂, LiAlO₄, LiAlCl₄, LiN(CₓF₂ₓ₊₁SO₂)(C_{y}F₂ₓ₊₁SO₂), where, x and y are positive integers.

Embodiments of the rechargeable battery with solid-state electrolyte support can include one or more of the following features. The anode and/or cathode can include a conductive active material selected from the group consisting of: a carbon based 3D nanomaterial, an inorganic nanostructured material, or a combination of the two. The carbon based 3D nanomaterial can be selected from the group consisting of: assembled carbon nanotubes (CNT), vertically aligned carbon nanotubes, carbon nanocups, carbon nanofibers, graphene, doped graphene, a hybrid of CNT and graphene, a hybrid of CNT and carbon nanocups, and carbon black. The inorganic nanostructured material can be a nanoparticle, a nanowire, or a nanosheet, each comprising a substance selected from the group consisting of a metal/semiconductor, a metal oxide, a metal phosphide, a metal nitride, and a metal sulfide; or a nanocomposite comprising two or more of these substances. Any known lithium battery chemistries can be employed.⁹

Yet another aspect of the present technology is a method of making an electrode. The method includes the steps of: (a) providing an electrode comprising a surface coated with a nanostructured active material, a polymer solution, and a conductive additive; (b) coating the nanostructured material with the polymer solution; (c) performing one or more freeze/thaw cycles on the product of step (b), whereby the polymer solution forms a hydrogel; (d) dehydrating the hydrogel, leaving a porous polymer membrane surrounding components of the nanostructured material; (e) soaking the porous polymer membrane in a solution comprising the conductive additive, whereby the conductive additive becomes incorporated into pores of the porous polymer membrane, and; (f) drying the porous polymer membrane to obtain the electrode. Embodiments of the method of making the electrode can include one or more of the following features. The conductive additive can be an acid, a salt, or an ionic liquid. The freezing and thawing can be repeated two to ten times. Drying can be performed at room temperature. Alternatively, drying can be performed at 80° C. under vacuum.

Still another aspect of the present technology is another method of making an electrode. The method includes the steps of: (a) providing an electrode comprising a surface coated with a nanostructured active material and a solution containing a polymer and a conductive additive; coating the nanostructured material with the solution; (c) performing one or more freeze/thaw cycles on the product of step (b), whereby the solution forms a hydrogel; and (d) dehydrating the hydrogel, leaving a porous polymer membrane and the conductive additive surrounding components of the nanostructured material, whereby the electrode is obtained.

The present technology is further summarized by the following list of embodiments.

1. A solid-state electrolyte comprising a porous polymer network containing a conductive additive selected from the group consisting of an acid, a salt dissolved in a non-aqueous solvent, and an ionic liquid.
2. The solid-state electrolyte of embodiment 1, wherein the polymer network comprises one or more polymers selected from the group consisting of poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide.
3. The solid-state electrolyte of embodiment 1 or embodiment 2, wherein the polymer network comprises a block co-polymer.
4. The solid-state electrolyte of any of the previous embodiments, wherein the polymer network comprises a hydrophobic polymer or a hydrophilic polymer.
5. The solid-state electrolyte of any of the previous embodiments, wherein the conductive additive is H₃PO₄.
6. The solid-state electrolyte of any of embodiments 1-4, wherein the conductive additive is an ionic liquid.
7. An electrode comprising:

an electrically conductive substrate;

a nanostructured active material layer deposited on the substrate; and

the solid-state electrolyte of any of the previous embodiments configured as a porous membrane coating the nanostructured active material.

8. The electrode of embodiment 7, wherein the nanostructured active material comprises a carbon-based 3D nanomaterial, an inorganic nanostructured material, or a combination thereof.
9. The electrode of embodiment 8, wherein the carbon-based 3D nanomaterial is selected from the group consisting of assembled carbon nanotubes, vertically aligned carbon nanotubes, carbon nanocups, carbon nanofibers, graphene, doped graphene, a hybrid of carbon nanotubes and graphene, a hybrid of carbon nanotubes and carbon nanocups, and carbon black.
10. The electrode of embodiment 7 or embodiment 8, wherein the inorganic nanostructured material is in the form of nanoparticles, nanowires, nanosheets, and/or nanocrystals and comprises a metal, a semiconductor, a metal oxide, a metal phosphide, a metal nitride, a metal sulfide, or a combination thereof.
11. The electrode of any of embodiments 7-10 configured for use in a battery or supercapacitor.
12. A supercapacitor comprising a pair of electrodes of embodiment 11.
13. A battery comprising a first electrode of embodiment 11 configured as an anode and a second electrode of embodiment 11 configured as a cathode.
14. The battery of embodiment 13 that is rechargeable.
15. The battery of embodiment 13 or embodiment 14 that is a lithium ion battery.
16. The battery of any of embodiments 13-15, wherein the porous membrane of the solid-state electrolyte serves as separator.
17. A method of making an electrode, the method comprising the steps of:
(a) providing (1) an electrode comprising a surface coated with a nanostructured active material, (2) a polymer solution, and (3) a conductive additive;
(b) coating the nanostructured material with the polymer solution;
(c) performing one or more freeze/thaw cycles on the product of step (b), whereby the polymer solution forms a hydrogel;
(d) dehydrating the hydrogel, leaving a porous polymer membrane surrounding components of the nanostructured material;
(e) soaking the porous polymer membrane in a solution comprising the conductive additive, whereby the conductive additive becomes incorporated into pores of the porous polymer membrane, and;
(f) drying the porous polymer membrane to obtain the electrode.
   18. The method of embodiment 17, wherein the freezing and thawing is repeated two to ten times.
   19. The method of embodiment 17 or embodiment 18, wherein the dehydrating is performed by soaking the hydrogel in successively higher concentrations of a water miscible solvent and finally in 100% solvent, followed by evaporating the solvent.
   20. The method of any of embodiments 17-19, wherein the nanostructured active material comprises a carbon-based 3D nanomaterial, an inorganic nanostructured material, or a combination thereof.
   21. The method of any of embodiments 17-20, wherein the polymer solution comprises one or more polymers selected from the group consisting of poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide.
   22. The method of any of embodiments 17-21, wherein the conductive additive is selected from the group consisting of an acid, a salt dissolved in a non-aqueous solvent, and an ionic liquid.
   23. A method of making an electrode, the method comprising the steps of:
(a) providing (1) an electrode comprising a surface coated with a nanostructured active material and (2) a solution containing a polymer and a conductive additive;
(b) coating the nanostructured material with the solution;
(c) performing one or more freeze/thaw cycles on the product of step (b), whereby the solution forms a hydrogel; and
(d) dehydrating the hydrogel, leaving a porous polymer membrane and the conductive additive surrounding components of the nanostructured material, whereby the electrode is obtained.
   24. The method of embodiment 23, wherein the freezing and thawing is repeated two to ten times.
   25. The method of embodiment 23 or embodiment 24, wherein the dehydrating is performed by soaking the hydrogel in successively higher concentrations of a water miscible solvent and finally in 100% solvent, followed by evaporating the solvent.
   26. The method of any of embodiments 23-25, wherein the nanostructured active material comprises a carbon-based 3D nanomaterial, an inorganic nanostructured material, or a combination thereof.
   27. The method of any of embodiments 23-26, wherein the polymer solution comprises one or more polymers selected from the group consisting of poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide.
   28. The method of any of embodiments 23-27, wherein the conductive additive is selected from the group consisting of an acid, a salt dissolved in a non-aqueous solvent, and an ionic liquid.

### BRIEF DESCRIPTION OF THE DRAWINGS

FIGS. 1A and 1B are schematic diagrams showing contact between electrode active material and an electrolyte when the electrolyte is a solution (FIG. 1A) and when it is a solid-state electrolyte (FIG. 1B).

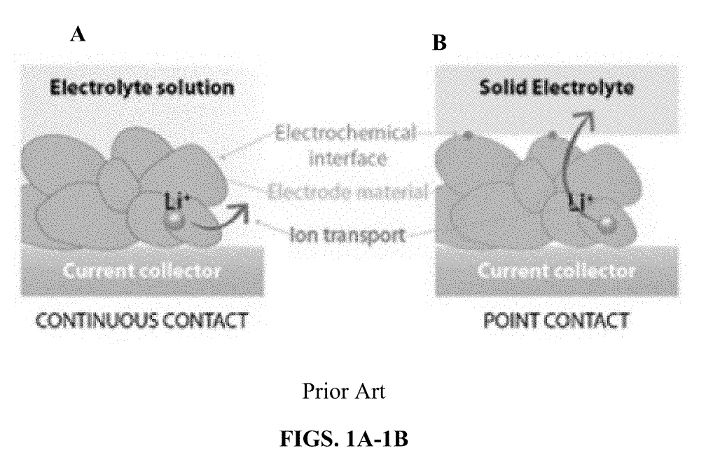

FIG. 2 is a diagram showing fabrication of a porous polyvinyl alcohol (PVA) film solid-state electrolyte.

FIG. 3A is a schematic diagram showing a method of fabrication of a reconfigurable electrode-solid-state electrolyte support. FIG. 3B is a schematic diagram showing coating of carbon nanotubes with a porous PVA membrane.

FIGS. 4A and 4B show schematic diagrams for supercapacitor assembly using electrodes and electrolytes made according to the present technology. The supercapacitor assembly shown in FIG. 4A uses a solid-state electrolyte containing a porous PVA film soaked with H₃PO₄, and that shown in FIG. 4B uses a solid-state electrolyte containing a porous PVA film soaked with an ionic liquid.

FIG. 5 shows a schematic diagram of a battery made from a 3D electrolyte-electrode serving as the anode and a 3D electrolyte-electrode serving as the cathode.

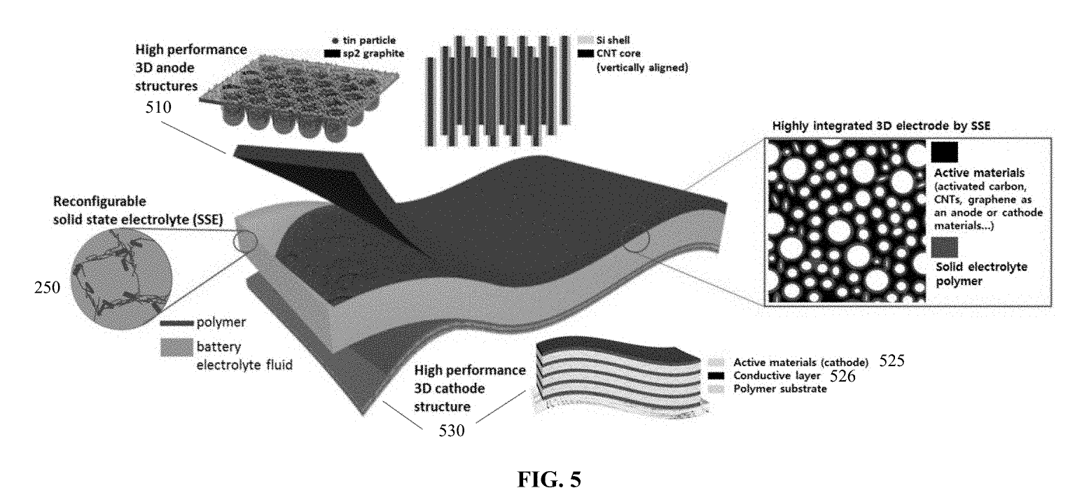

FIGS. 6A-6E show photographs of PVA solid-state electrolyte films. FIG. 6A shows a PVA hydrogel prior to dehydration with IPA, while FIG. 6C shows a porous PVA film after IPA treatment. FIG. 6B shows the films of FIGS. 6A and 6C side by side. FIGS. 6D-6E show the flexibility of the solid-state electrolyte system. FIG. 6D shows a PVA hydrogel prior to dehydration with IPA. FIG. 6E shows a PVA film after dehydration with IPA. FIG. 6F shows an SEM image of a PVA-hydrogel film without IPA treatment, and FIG. 6G shows a porous PVA film after IPA treatment.

FIGS. 7A-7F show results of the characterization of supercapacitor assemblies made according to the present technology. Two different solid-state electrolytes were used with either H₃PO₄ (FIGS. 7A, 7B, and 7C) or an ionic liquid as additive (FIGS. 7D, 7E, and 7F). FIGS. 7A and 7D show Nyquist plots (insets) showing a semicircle at high frequencies followed by a straight line at medium/low frequencies. FIG. 7B is a cyclic voltammetry plot of currents observed with different scan rates. FIG. 7C is a plot showing specific capacitances at different current densities. Inset shows galvanostatic charge/discharge curves at different current densities. FIG. 7E shows cyclic voltammetry curves at 50 mV/s with different set voltages. FIG. 7F is a comparison of galvanostatic charge/discharge curves at 0.8 V and 2 V; the current density was 1 A/g.

### DETAILED DESCRIPTION

The present technology provides a new method for fabricating a highly integrated, flexible, reconfigurable, and miniaturizable combined electrode/solid-state electrolyte system for use in batteries and supercapacitors. A key component of the electrode/electrolyte system is a porous, flexible, 3D polymer network (also referred to herein as a “membrane” or “polymer film”) made from a polymer-based hydrogel. The membrane coats a nanostructured active material deposited on the electrode's conductive surface. Additionally, the solid-state electrolyte contains one or more conductive additives and enhances the access of ions and electrons to the nanostructured active material. Such electrodes are suitable for the production of devices, such as lightweight and flexible, all solid-state, high-performance supercapacitors; batteries, and sensors for use in portable, wearable, and flexible electronic devices, electric and hybrid-electric vehicles, and energy-efficient cargo ships, locomotives, and aircraft.

Nanomaterials used as active materials in batteries and supercapacitors have a high surface-to-volume ratio which increases the area of contact between the electrolyte and electrode leading to improved power density and energy efficiency. The nanosize dimensions of the components of such materials effectively reduces the distance that ions and electrons must travel during cycling in the solid state through electrode materials. However, nanomaterials have low tapped density (packing density) which leads to reduced volumetric energy density. Without being bound to any theory or mechanism of action, it is believed that the porous flexible membrane described herein, which swells when soaked in an electrolyte solution, fills the voids between the particles, thereby enhancing volumetric energy density. Many nanostructures are known which can be used as active materials on electrodes of the present technology.¹⁰⁻¹¹

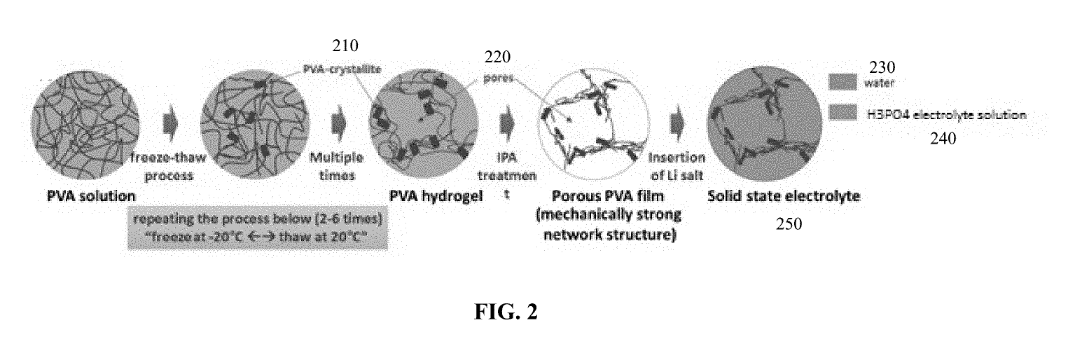

A method for making the above-described electrode/electrolyte system (sometimes referred to herein as an “electrode”) requires formation of a hydrogel on an electrode surface, and drying of the hydrogel to form a porous polymer film or membrane containing one or more conductive additives. The hydrogel is formed by depositing on the active elements of the electrode surface a solution containing one or more polymers or polymer precursors (e.g., monomeric units) and containing the conductive additive(s) in a suitable solvent. During cycles of freezing and thawing, some of the polymer material forms crystallites (see FIG. 2, reference numeral 210), leaving open pores 220 in the structure. The hydrogel is saturated with water 230, which is removed by solvent exchanged and replaced with electrolyte solution (e.g., phosphoric acid solution 230 or ionic liquid 240) to yield the solid-state electrolyte 250.

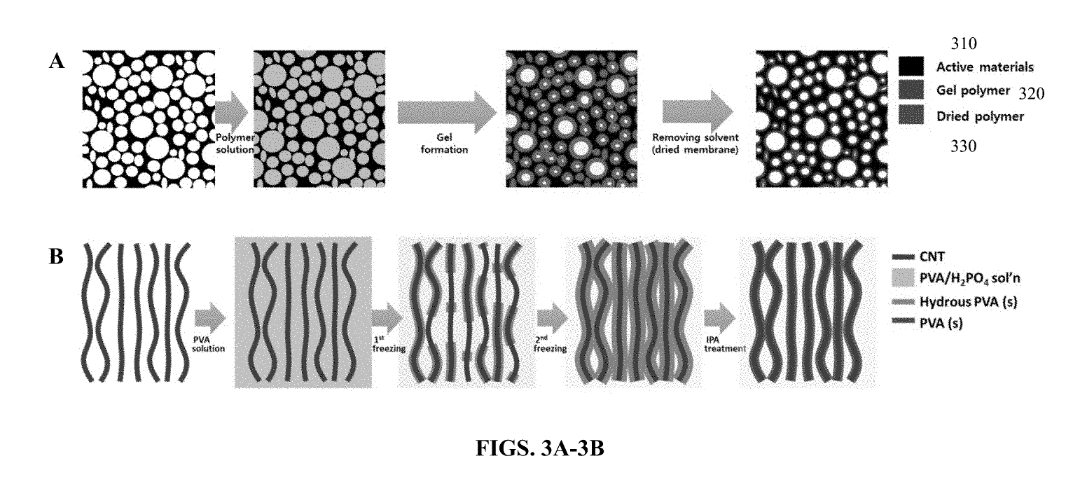

Once the hydrogel is formed on the electrode, the solvent is removed to form the electrode/solid-phase electrolyte system. A preferred method of removing the solvent is by solvent exchange, during which the initial solvent is removed and gradually replaced with a volatile solvent that can be readily and completely removed to form a porous mechanically stable film. Optionally, the polymer film can be soaked in further solutions to add additional components, such as conductive additives, cross-linking agents, preservatives, and the like (see FIGS. 3A and 3B). The polymer film coats and integrates with active material layer 310, initially with hydrogel layer 320 which forms dried polymer film 330.

The porosity of the polymer network of the solid-state electrolyte of the present technology is necessary in order to maintain a pathway for diffusion of ions to and from the active material on the electrode, and to maintain a conductive ion pathway between the electrodes of a device such as a supercapacitor or battery that contains more than one such electrode. The characteristics of the polymer network can be adjusted in order to control the electrical properties of a supercapacitor or battery in which the electrode/solid-state electrolyte system is used. Thus, properties such as pore size, pore density, porosity, thickness, and tortuosity can be adjusted by selecting the starting conditions, materials, and fabrication method of the polymer network together with the conductive additives (type and concentration) contained within the polymer network. In general, larger pore size leads to larger capacitance. The fabrication conditions (such as freeze/thaw process and number of cycles) and materials can be adjusted while using the capacitance, series resistance, energy density, and/or discharge rate values as feedback for optimizing the structure, performance, and fabrication of the final integrated electrode/solid-phase electrolyte system. The porosity of the solid-state electrolyte material of the present technology is also sensitive to drying conditions used during fabrication, both after dehydration or other solvent exchange and after final impregnation with electrolyte. If drying is performed to quickly or under harsh conditions (e.g., excessive temperature, time, or positive or negative pressure), the polymer network can lose sufficient porosity as to degrade the electrical properties of the integrated electrode/electrolyte system or a device in which it is used.

While it is preferable to use the polymer film of the present technology as a replacement for a conventional separator in a supercapacitor or battery device, a separator optionally can be added in such a device if required to achieve desired properties of the device.

In another embodiment of a method for making an electrode/solid-phase electrolyte system, the polymer solution is initially devoid of conductive additive, which are added after the porous polymer film is formed by soaking the film in a solution containing the desired ions or in an ionic liquid that serves as the conductive additive.

The present technology affords many advantages. The method for making the electrode provides a simple and efficient process for integrating electrodes with a conductive matrix, avoiding the need for adding a separate solid or liquid electrolyte. Impregnation of the electrode can be performed at the same time as the formation of the gelled matrix. The fabrication method ensures a good interface between the gel matrix and the electrode active material which is important for minimizing contact resistance in the final device. A mechanically stable porous membrane is formed by a simple to perform solvent exchange step followed by drying. The presence of the membrane covering the electrode surface avoids the need for adding a separator when combining two electrodes in a battery or supercapacitor, as the membrane serves the role of a separator, preventing shorting between the electrodes and regulating the ionic environment at the electrode surface.

The dry porous membrane coating the electrode active material serves as a versatile template that can be used to apply desired ions to the electrode. Such ions can be introduced by soaking the membrane in a liquid containing the ions required for a specific device. Soaking leads to swelling of the membrane which promotes access of ions and electrons present in the bulk electrolyte solution to the nanostructured active material on the electrode. The dimensions of the pores of the membrane can be controlled by different means, including by selecting an amount of solid content in the polymer or polymer-additive solution (by selecting a suitable concentration of initially dissolved polymer or polymer precursor), by the temperature during the polymerization or gelation process, or by applying positive or negative pressure, optionally with heat, during the dehydration and drying process. Uniform pores, high mechanical strength, and enhanced accessibility of ions to the electrode all serve to protect the electrode and the solvent inside the battery or supercapacitor cell, thereby ensuring higher and more stable cycling ability than with earlier technologies.

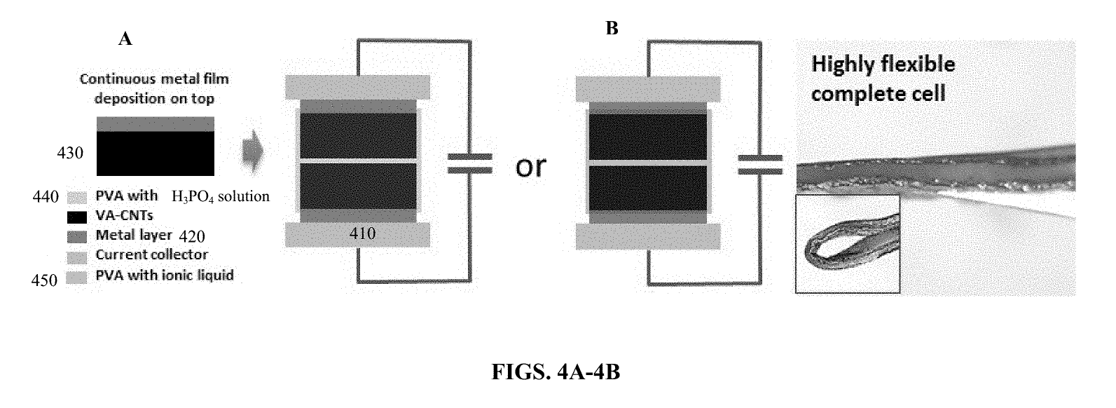

The above-described electrode can be used in the construction of a supercapacitor. Accordingly, the present technology provides a supercapacitor having two such electrodes. Since each electrode is actually an integrated electrode/electrolyte system, and includes a membrane (3D polymer network that serves as a semipermeable membrane and contains an ionic solution or an ionic liquid), no additional separator or electrolyte is required. The supercapacitor can be made by simply layering the two electrodes over one another. If desired, the PVA-CNT structures can be covered by a metal layer such as gold, silver or chromium to provide support and electrical contact. FIGS. 4A and 4B show schematic diagrams of two embodiments of the supercapacitor. A current collector 410 is connected to the metal layer 420 of each electrode. The electrode active materials (e.g., CNT 430) are coated with the solid-state electrolyte polymer layer containing electrolyte (e.g., PVA containing phosphoric acid solution 440 or PVA containing ionic liquid 450). The two forms differ in the source of ions in the solid-phase electrolyte. One uses H₃PO₄ (FIG. 4A) as the source of ions (other sources of ions also can be used), and the other uses an ionic liquid (FIG. 4B). The use of flammable or explosive organic solvents can be avoided.

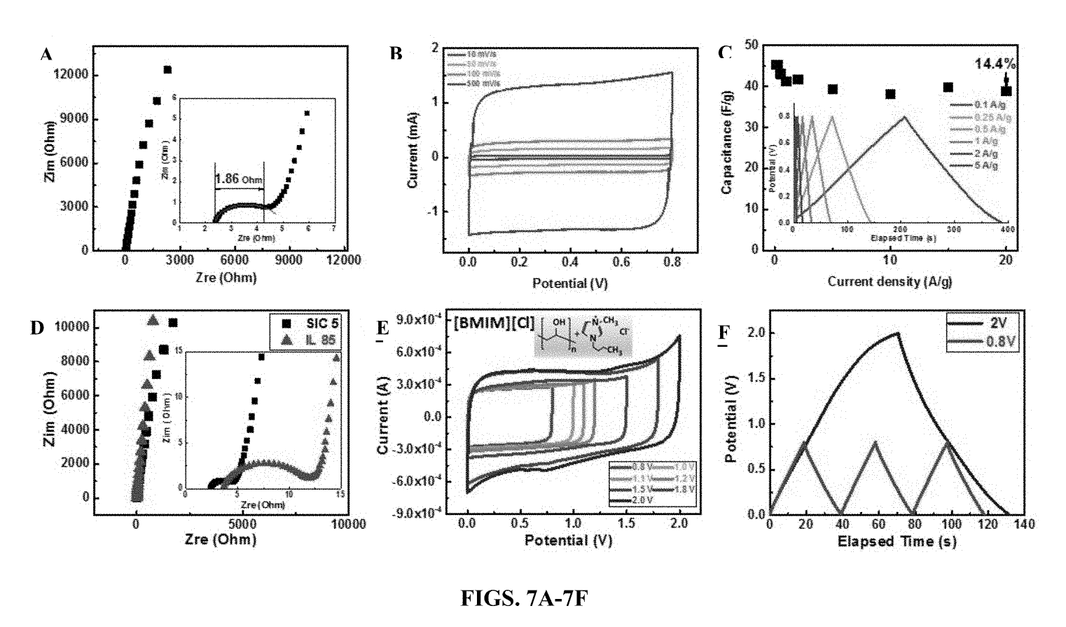

Detailed characterization of supercapacitors is provided in Example 5. Standard electrochemical methods, such as impedance spectroscopy, cyclic voltammetry, and galvanostatic charge/discharge measurements can be used for characterization. Results obtained for supercapacitors using H₃PO₄ and an ionic liquid as the electrolyte are shown FIGS. 7A-7C and 7D-7F, respectively. The supercapacitors were found to have low equivalent series resistance (ESR), which is due in part to the efficient integration of the electrode and the electrolyte into the supercapacitor assembly. Box-like shape of cyclic voltammetry traces (FIG. 7B) indicated that the charge stored was due to the formation of an electrochemical double layer. Reversible capacitive performance was reflected by the linear, symmetric (close to 100% Columbic efficiency), and triangular shape of galvanostatic charge/discharge traces (FIGS. 7A and 7C). Further, a good charge/discharge rate capability was reflected by the observation that the supercapacitors retained 86% of their capacitance with increasing current densities from 0.1 A/g to 20 A/g. These and other characteristics of the supercapacitors can largely be ascribed to the generation of a well-functioning electrode-electrolyte interface that allows for good wetting of the electrode by the electrolyte, thereby allowing enhanced access of ions and electrons to the high surface area nanomaterial on the electrode.

The integrated electrode/solid-state electrolyte system of the present technology can be used in the construction of non-rechargeable or rechargeable batteries. In one embodiment, such rechargeable batteries have at least one integrated electrode/solid-phase electrolyte of the present technology, and preferably have two such electrodes. Because the integrated electrode/electrolyte includes the electrolyte, no additional electrolyte is needed (although a solid or liquid electrolyte optionally can be added), and no separator is required because of the presence of a porous membrane enclosing the electrolyte. A battery can be made simply by combining suitable electrodes which serve as the anode and cathode for the battery. A case and positive and negative contact structures can be added to enclose and/or provide contact with the electrodes. The materials chosen for the anode and cathode, as well as their electrolyte materials, particularly the conductive additives, provide the required chemistry for the battery.

### EXAMPLES

### Example 1. Preparation of a Porous, Flexible Solid-State Electrolyte Film

The fabrication of a porous polyvinyl alcohol (PVA) film solid-state electrolyte is schematically shown in FIG. 2. PVA was dissolved in water under mechanical stirring at 80° C. To the resultant solution 1.5M H₃PO₄ was added with stirring. The PVA-H₃PO₄ solution was transferred to a petri dish and placed in a freezer for 12 hours. The petri dish was then removed from the freezer and allowed to come to room temperature and maintained at that temperature for 20 min. This process was repeated two to six times until a hydrogel film was formed. Next, solvent exchange was performed by placing the hydrogel in isopropyl alcohol (IPA)-water solutions having increasing concentrations of IPA (30%, 50%, 70%, and finally 100% IPA). The hydrogel was kept in each IPA solution for one day. After solvent exchange was complete, the film was dried at ambient temperature. A mechanically stable and porous film was thus obtained. Drying under vacuum in an oven at 80° C. was also found suitable. The porous film was soaked in increasing concentrations (0.5M to 6M) of H₃PO₄ over one day in order to obtain a solid, flexible electrolyte film. It was observed that drying the hydrogel without solvent exchange caused the film to shrink and lose porosity.

### Example 2. Fabrication of an Integrated Electrode/Solid-State Electrolyte System

The fabrication of a reconfigurable electrode/solid-electrolyte system is shown schematically in FIGS. 3A and 3B. FIG. 3A shows the general fabrication process, and FIG. 3B shows formation of a PVA film formed over vertically aligned carbon nanotubes. PVA was dissolved in water with stirring and at 80° C. To the resultant solution, 1.5M H₃PO₄ was added while stirring. The PVA-H₃PO₄ solution was poured into a petri dish containing nanotubes supported on a silicon wafer. To ensure wetting and eliminate air bubbles, the petri dish was transferred to a desiccator and left under vacuum for 20 min, and placed in a freezer for 12 hours. After removal from the desiccator, the petri dish was placed in a freezer for 24 hours. Next, the petri dish was removed from the freezer, warmed to room temperature, and kept at room temperature for 20 minutes. This procedure was repeated 2 to 6 times until a hydrogel film was formed. The hydrogel film was sequentially placed in IPA-distillated water mixtures having increasing concentrations of IPA (30%, 50%, 70% IPA, and finally 100% IPA) for solvent exchange. The film was kept in each solution for a day. After solvent exchange, the film was dried at ambient temperature and pressure or at 80° C. under vacuum. A highly integrated electrode/solid-phase electrolyte structure was obtained.

### Example 3. Fabrication of Solid-State, Flexible Supercapacitors

Supercapacitors having highly integrated, porous, and flexible electrode/solid-state-electrolyte films were prepared using a vertically aligned carbon nanotube array, poly(vinyl alcohol), and H₃PO₄ solution or an ionic liquid as electrolyte. The electrode/solid-state electrolyte structures were prepared as described in Example 2 and then soaked in a 1.5M H₃PO₄ solution or in a hydrophilic ionic liquid to obtain the final electrode/solid-state electrolyte system. FIGS. 4A and 4B show the sandwiched structure formed by two integrated electrode/electrolyte structures facing each other, one soaked in H₃PO₄ and the other in a hydrophilic ionic liquid.

### Example 4. Fabrication of Solid-State, Flexible Batteries

A battery having two integrated electrode/solid-state electrolyte structures together with a lithium salt as conductive additive are prepared by the process depicted in FIG. 4. The anode includes high performance nanoscale active material structures (carbon nanocups made of graphene with tin particles distributed on the graphene surface or vertically aligned carbon nanotubes with Si shells). A high performance 3D cathode structure is fabricated by assembling several alternating layers of cathode active materials and conductive layers consisting of solid-state electrolyte prepared according to the process described in Example 2.

### Example 5. Functional Characterization of Solid-State Flexible Supercapacitors

Supercapacitors made according to the process described in Example 3 were characterized by impedance spectroscopy, cyclic voltammetry, and galvanostatic charge/discharge measurements. Two different electrolyte systems were used in the design of the suprcapacitors: (1) H₃PO₄ (results shown in FIGS. 7A-7C), and (2) an ionic liquid (85% BMIMCl (1-butyl-3-methylimidazolium chloride, results shown in FIGS. 7D-7F). Nyquist plots (FIGS. 7A and 7D) obtained from impedance spectroscopy measurements show a semicircle at high to medium frequencies followed by a straight line at low frequencies (inset). From the semicircle one can observe low ESR (equivalent series resistance) made possible in part by the efficient integration of the electrode/electrolyte into the supercapacitor assembly. The line close to 90° indicates good capacitive behavior. Cyclic voltammetry was performed at different rates from 10 mV/s to 500 mV/s as can be seen in the results shown in FIG. 7B. It is possible to observe a box-like shape characteristic of electrical double layer supercapacitors even at high rates such as 500 mV/s, indicating that the stored charge is due to an electrochemical double layer. Further, the galvanostatic charge/discharge trace is linear, symmetric (close to 100% Columbic efficiency), and triangular, implying reversible capacitive performance (FIGS. 7C and 7F). In FIG. 7C, the capacitance (considering one electrode) is on the order of 45.4 F/g (from the discharge curve) which is close to other solid-state carbon nanotube based supercapacitors. The capacitance value could be increased by changes to the polymer film-CNT size, porosity of the membrane, and the nature of the electrolyte. The supercapacitor retained 86% of its capacitance with increasing current densities from 0.1 A/g to 20 A/g, reflecting good rate capability. The power density changed from 15 W/kg to 3,204 W/kg while the energy remained practically constant (0.8 Wh/kg to 0.7 Wh/kg) in the range of current density studied.

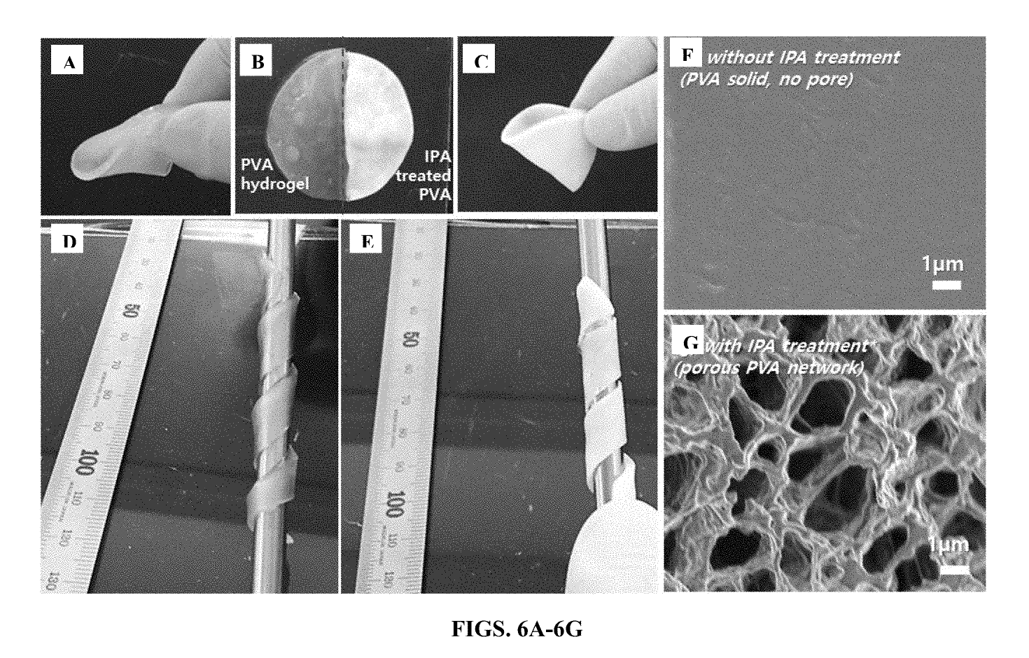

The structure obtained by the integration procedure as described in Example 2 makes it possible to have a high cycle life with lower capacitance loss after 10,000 cycles. These characteristics are a result of high integration between the supercapacitor components which ensures proper electrode/electrolyte interface, guaranteeing extensive wetting of the electrode and access of ions to the high surface area porous polymer film (with narrow pore size effective for double-layer accumulation), and also a result of film porosity, which ensures access of electrolyte from the bulk of the film to the surface of the nanotubes. Results of cyclic voltammetry experiments performed with different electrochemical windows from 0.8 to 2.0V at 50 mV/s are shown in FIG. 7E. The electrochemical window was widened using the hydrophilic ionic liquid 85% BMIMCl in water. The galvanostatic charge/discharge traces (FIG. 6E) show liner, symmetric, and triangular shapes for both 0.8V and 2.0V.

### REFERENCES

1. Xu, Qiang, and Tetsuhiko Kobayashi, eds. Advanced materials for clean energy. CRC Press, 2015, ch. 9, 271
2. Anothumakkool, Bihag, et al. High-Performance Flexible Solid-State Supercapacitor with an Extended Nanoregime Interface through in Situ Polymer Electrolyte Generation. ACS applied materials & interfaces 8.2 (2016): 1233-1241.
3. Hahm, Myung Gwan, et al. Carbon nanotube-nanocup hybrid structures for high power supercapacitor applications. Nano letters 12.11 (2012): 5616-5621.
4. Xu, Yuxi, et al. Flexible solid-state supercapacitors based on three-dimensional graphene hydrogel films. ACS nano 7.5 (2013): 4042-4049.
5. Yu, Zhexun, et al. Highly efficient quasi-solid-state quantum-dot-sensitized solar cell based on hydrogel electrolytes. Electrochemistry Communications 12.12 (2010): 1776-1779.
6. Meng, Chuizhou, et al. Highly flexible and all-solid-state paperlike polymer supercapacitors. Nano letters 10.10 (2010): 4025-4031.
7. Ruiz, Vanesa, et al. Long-term cycling of carbon-based supercapacitors in aqueous media. Electrochimica acta 54.19 (2009): 4481-4486.
8. en.wikipedia.org/wiki/Quaternary ammonium cation
9. Manthiram, A. et al. Lithium battery chemistries enabled by solid-state electrolytes. Nature Reviews—Materials (2017), Article No. 16103, pages 1-16.
10. Nasir Mahmood and Yanglong Hou. Electrode Nanostructures in Lithium-Based Batteries. Adv. Sci. 2014, 1, 1400012, 1-20.
11. Song, Min-Kyu et al. Nanostructured electrodes for lithium-ion and lithium-air batteries: the latest developments, challenges, and perspectives. Materials Science and Engineering R 72 (2011) 203-252.

As used herein, “consisting essentially of” allows the inclusion of materials or steps that do not materially affect the basic and novel characteristics of the claim. Any recitation herein of the term “comprising”, particularly in a description of components of a composition or in a description of elements of a device, can be exchanged with “consisting essentially of” or “consisting of”.

While the present technology has been described in conjunction with certain preferred embodiments, one of ordinary skill, after reading the foregoing specification, will be able to effect various changes, substitutions of equivalents, and other alterations to the compositions and methods set forth herein.

All publications referenced herein are incorporated by reference in their entirety.

What is claimed is:

1. A solid-state electrolyte comprising a porous polymer network containing a conductive additive selected from the group consisting of an acid, a salt dissolved in a non-aqueous solvent, and an ionic liquid.

2. The solid-state electrolyte of claim 1, wherein the polymer network comprises one or more polymers selected from the group consisting of poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide.

3. The solid-state electrolyte of claim 1, wherein the polymer network comprises a block co-polymer.

4. The solid-state electrolyte of claim 1, wherein the polymer network comprises a hydrophobic polymer or a hydrophilic polymer.

5. The solid-state electrolyte of claim 1, wherein the conductive additive is H₃PO₄.

6. The solid-state electrolyte of claim 1, wherein the conductive additive is an ionic liquid.

7. An electrode comprising:
an electrically conductive substrate;
a nanostructured active material layer deposited on the substrate; and
the solid-state electrolyte of claim 1 configured as a porous membrane coating the nanostructured active material.

8. The electrode of claim 7, wherein the nanostructured active material comprises a carbon-based 3D nanomaterial, an inorganic nanostructured material, or a combination thereof.

9. The electrode of claim 8, wherein the carbon-based 3D nanomaterial is selected from the group consisting of assembled carbon nanotubes, vertically aligned carbon nanotubes, carbon nanocups, carbon nanofibers, graphene, doped graphene, a hybrid of carbon nanotubes and graphene, a hybrid of carbon nanotubes and carbon nanocups, and carbon black.

10. The electrode of claim 7, wherein the inorganic nanostructured material is in the form of nanoparticles, nanowires, nanosheets, and/or nanocrystals and comprises a metal, a semiconductor, a metal oxide, a metal phosphide, a metal nitride, a metal sulfide, or a combination thereof.

11. The electrode of claim 7 configured for use in a battery or supercapacitor.

12. A supercapacitor comprising a pair of electrodes of claim 11.

13. A battery comprising a first electrode of claim 11 configured as an anode and a second electrode of claim 11 configured as a cathode.

14. The battery of claim 13 that is rechargeable.

15. The battery of claim 13 that is a lithium ion battery.

16. The battery of claim 13, wherein the porous membrane of the solid-state electrolyte serves as separator.

17. A method of making an electrode, the method comprising the steps of:
(a) providing (1) an electrode comprising a surface coated with a nanostructured active material, (2) a polymer solution, and (3) a conductive additive;
(b) coating the nanostructured material with the polymer solution;
(c) performing one or more freeze/thaw cycles on the product of step (b), whereby the polymer solution forms a hydrogel;
(d) dehydrating the hydrogel, leaving a porous polymer membrane surrounding components of the nanostructured material;
(e) soaking the porous polymer membrane in a solution comprising the conductive additive, whereby the conductive additive becomes incorporated into pores of the porous polymer membrane, and;
(f) drying the porous polymer membrane to obtain the electrode.

18. The method of claim 17, wherein the freezing and thawing is repeated two to ten times.

19. The method of claim 17, wherein the dehydrating is performed by soaking the hydrogel in successively higher concentrations of a water miscible organic solvent and finally in 100% organic solvent, followed by evaporating the organic solvent.

20. The method of claim 17, wherein the nanostructured active material comprises a carbon-based 3D nanomaterial, an inorganic nanostructured material, or a combination thereof.

21. The method of claim 17, wherein the polymer solution comprises one or more polymers selected from the group consisting of poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide.

22. The method of claim 17, wherein the conductive additive is selected from the group consisting of an acid, a salt dissolved in a non-aqueous solvent, and an ionic liquid.

23. A method of making an electrode, the method comprising the steps of:
(a) providing (1) an electrode comprising a surface coated with a nanostructured active material and (2) a solution containing a polymer and a conductive additive;
(b) coating the nanostructured material with the solution;
(c) performing one or more freeze/thaw cycles on the product of step (b), whereby the solution forms a hydrogel; and
(d) dehydrating the hydrogel, leaving a porous polymer membrane and the conductive additive surrounding components of the nanostructured material, whereby the electrode is obtained.

24. The method of claim 23, wherein the freezing and thawing is repeated two to ten times.

25. The method of claim 23, wherein the dehydrating is performed by soaking the hydrogel in successively higher concentrations of a water miscible organic solvent and finally in 100% organic solvent, followed by evaporating the organic solvent.

26. The method of claim 23, wherein the nanostructured active material comprises a carbon-based 3D nanomaterial, an inorganic nanostructured material, or a combination thereof.

27. The method of claim 23, wherein the polymer solution comprises one or more polymers selected from the group consisting of poly(vinyl alcohol), poly(vinylpyrrolidone), poly(acrylic acid), polyurethane, poly(ethylene glycol), poly(propylene glycol), poly(vinyl methyl ether), poly(N-isopropyl acrylamide), polymethacrylate, poly(vinyl methyl ether) and poly(N-isopropyl acrylamide.

28. The method of claim 23, wherein the conductive additive is selected from the group consisting of an acid, a salt dissolved in a non-aqueous solvent, and an ionic liquid.
